(19) United States
(12) Patent Application Publication
(10) Pub. No.: US 2010/0050535 A1
(43) Pub. Date: Mar. 4, 2010

(54) DETECTOR OF ATTEMPT TO BREAK A LOCK, LOCK, DOOR AND ALARM SYSTEM COMPRISING SUCH A DETECTOR

(76) Inventor: Madeleine Brimont, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/438,074

(22) PCT Filed: Aug. 23, 2007
(86) PCT No.: PCT/FR2007/001394

§ 371 Date: Jun. 25, 2009

(30) Foreign Application Priority Data
Aug. 23, 2006 (FR) PCT/FR2006/001973

(51) Int. Cl. E05B 63/00; E06B 3/00; E05B 45/06

(52) U.S. Cl. 49/503; 70/1.5; 340/542

(57) ABSTRACT

An attempted lock break-in detector of the invention comprising: a cover (1) provided with mounting means (2) for mounting on a door (3) provided with a lock (4), said cover (1) being capable of passing from a first position in which it covers means (40) for opening or closing said lock (4) so as to make said means inaccessible, to a second position in which it allows access to said opening or closing means (40), and vice versa; and means (51, 52) for opening and closing an electric circuit (6) to generate and interrupt an electrical signal (S1, S2) indicative of said cover (1) passing from the first position to the second position, and vice versa; said means (51, 52) for opening and closing an electric circuit (6) comprise at least one contact element (51) for making contact with an element (41) of said lock (4), which lock element constitutes a section of said electric circuit (6). The invention also provides a lock, a door, and an alarm system including such a detector.

The invention relates to a detector for detecting an attempt at breaking in by breaking a lock, and to a lock provided with such a detector, to a door provided with such a lock, and to an alarm system comprising such a detector and an alarm unit.

An alarm system for a dwelling generally comprises an alarm unit and a plurality of sensors, e.g. movement sensors, volume sensors, presence sensors, sensors for sensing the opening of a door or a window, etc. When one of the sensors detects an event that might be indicative of a break-in, it transmits a signal to the alarm unit. On receiving this signal, the alarm unit decides whether or not to trigger an alarm signal, such as a siren, a telephone call, etc.

A drawback of conventional alarm systems is that in general they are activated only once the break-in has actually been committed, e.g. once a wrongdoer has managed to open a door and penetrate into a dwelling. The intruder thus has the time, before taking flight, to steal articles, or to cause damage, whether intentionally or unintentionally. At very least, a lock, a door, or a window will have been forced, and therefore damaged, thus making expensive repairs or replacements necessary.

Document EP 0 052 891 discloses an attempted lock break-in detector that comprises a plate that can pivot between a first position in which it overlies a keyhole of a lock, and a second position in which it allows access to said lock. When the plate is taken from the first position to the second position in order to access the lock, a timer is put into operation to trigger an alarm if the plate remains in its second position for longer than a predetermined time, e.g. because a thief is trying to force the lock.

The device described in document EP 0 052 891 is unsatisfactory since it is possible to obtain free access to the lock without triggering the time alarm, merely by folding or cutting the plate instead of moving it to its second position.

An object of the invention is to remedy that drawback.

This object is achieved by an attempted lock break-in detector comprising: a cover provided with mounting means for mounting on a door provided with a lock, said cover being capable of passing from a first position in which it covers means for opening or closing said lock (typically a keyhole) so as to make said means inaccessible, to a second position in which it allows access to said opening or closing means, and vice versa; and means for opening and closing an electric circuit to generate and interrupt an electrical signal indicative of said cover passing from the first position to the second position, and vice versa; the detector being characterized in that said means for opening and closing an electric circuit comprise at least one contact element for making contact with an element of said lock, which lock element constitutes a section of said electric circuit.

In particular, said contact element may be arranged in such a manner as to be in contact with said element of the lock to close said electric circuit when the cover is in its first position, and to be spaced apart from said element of the lock to open said electric circuit when the cover is in its second position.

Under normal conditions, the cover is in the first position and it prevents access to the lock. When a person provided with the right key seeks to open the door, the cover is moved into the second position, thereby generating a first signal, the person opens the door and then removes the key, thus allowing the cover to return to the first position and causing a second signal to be generated. This operation requires only a few seconds and is therefore recognized as being legitimate. In contrast, a potential intruder seeking to force the lock needs to have access thereto for a much greater length of time. The fact that generation of the first signal is not followed by generation of the second signal before a predetermined duration has elapsed is indicative of a situation that is abnormal and therefore causes an alarm signal to be triggered.

An advantage of the detector of the invention, compared with that of document EP 0 052 891, is that its structure makes it intrinsically impossible to access the lock without generating the first signal, thereby triggering the alarm timer. The fact that a contact element secured to the cover co-operates with an element of the lock itself in order to close the electric circuit makes it impossible to access the lock without opening (i.e. interrupting) said circuit.

In particular embodiments of the attempted lock break-in detector of the invention:

said means for generating a signal indicative of said cover passing from the first position to the second position or vice versa may comprise means for opening and closing an electric circuit; in particular, said means may comprise at least one contact element for making contact with an element of said lock (typically a cylinder), said element constituting a section of said electric circuit;

in particular, said means for opening and closing an electric circuit may comprise at least a first contact element that, when said cover is in said first position, is in contact with a side surface of said cylinder projecting from said door, and that, when said cover is in said second position, is no longer in contact with said cylinder. Advantageously, said means for opening and closing an electric circuit may also comprise a second contact element that, when said cover is in said first position, is in contact with a front surface of said cylinder, and that, when said contact is in said second position, is no longer in contact with said cylinder. Advantageously, said at least one contact element is magnetized;

the detector may also include return means for returning said cover from said second position towards said first position;

the mounting means of said cover may be adapted to enable said cover to pivot about an axis perpendicular to the surface of said door; in particular said mounting means of said cover may comprise: a tubular element for passing through said door; a pin fastened to said cover at one of its ends and extending perpendicularly thereto, said pin being adapted to pass through said tubular element and to pivot in the tubular element; and retention means for retaining said pin inside said tubular element. Advantageously, said pin may include an axial opening through which there passes at least one, and, preferably, two electric wires connected to said means for generating a signal indicative of said cover passing from the first position to the second position, and vice versa;

the detector may also include at least one display means suitable for indicating whether said cover is in the first position or in the second position;

the detector may also include an auxiliary lock for locking said cover in said first position; and

the detector may also include timer means for generating a signal indicative of an attempted break-in if said cover, after being taken from the first position to the second position, does not return to said first position before a predetermined duration has elapsed.

The invention also provides an alarm system incorporating such an attempted lock break-in detector and an alarm unit. The invention also provides a lock provided with such an attempted lock break-in detector and a door provided with such a lock.

Other characteristics, details, and advantages of the invention appear on reading the following description made with reference to the accompanying drawings given by way of example and in which:

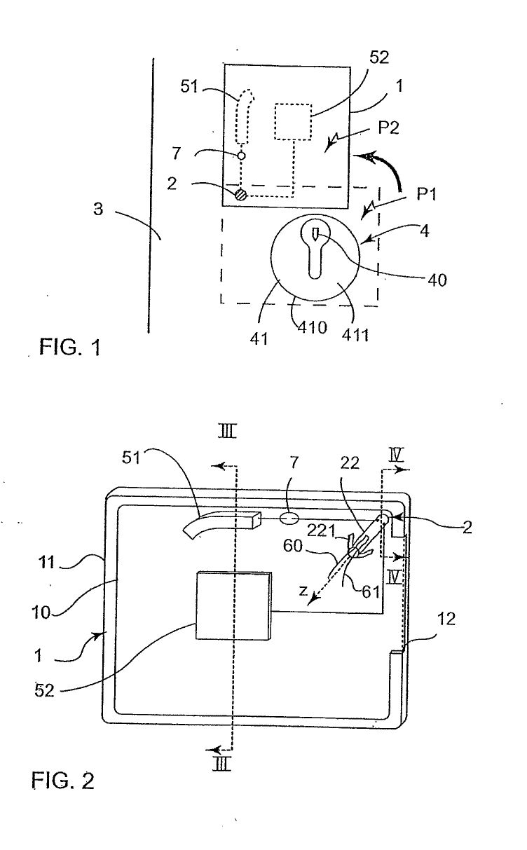

FIG. 1 is a front view of an attempted lock break-in detector of the invention;

FIG. 2 is a rear view of the FIG. 1 attempted lock break-in detector;

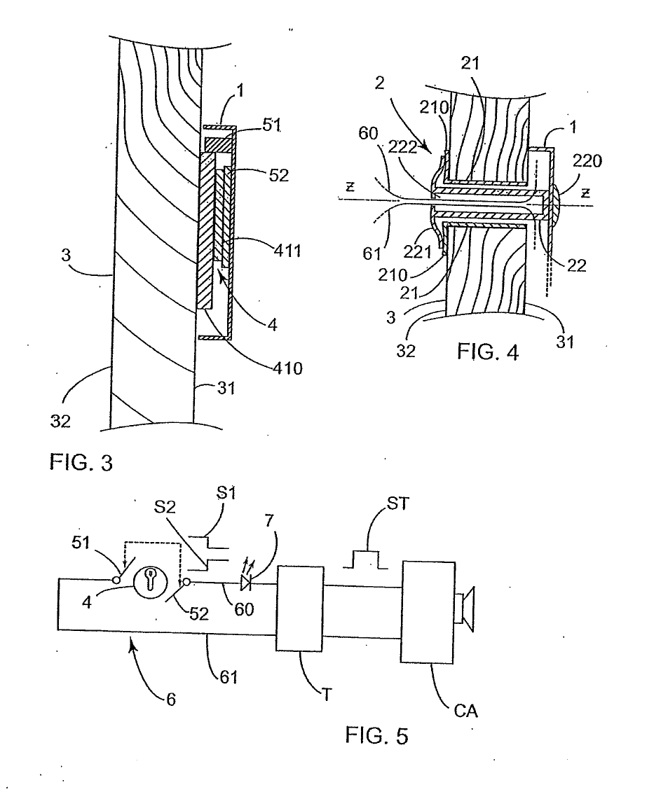

FIGS. 3 and 4 are section views on line III-III and IV-IV respectively showing the same detector;

FIG. 5 is a schematic of an alarm system incorporating the attempted lock break-in detector of the invention; and

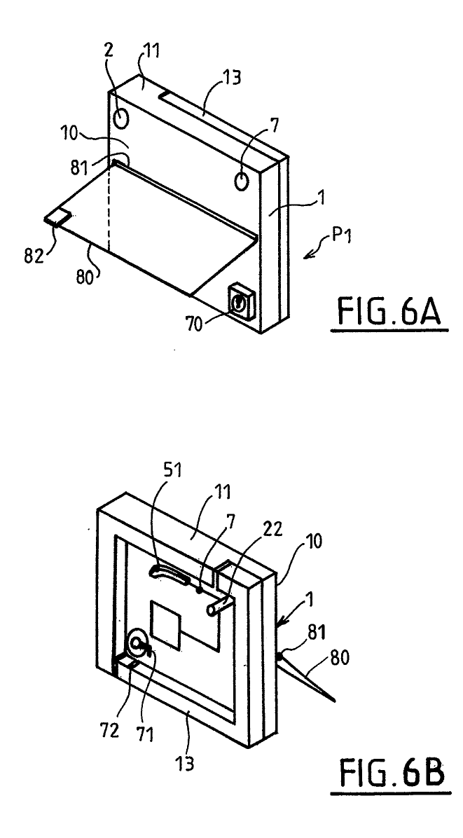

FIGS. 6A and 6B are elevation views respectively of the front face and of the rear face of a variant attempted lock break-in detector of the invention.

The detector of FIG. 1 is constituted essentially by a cover 1, e.g. of rectangular shape, that is pivotally fastened on a door 3 provided with a lock 4. Because of the fastening pivot 2, the cover 1 can pass from a first position P1 (in dashed lines in FIG. 1) in which it covers a keyhole 40 of the lock 4, to a second position P2 (in continuous lines) in which it uncovers said keyhole 40. It will readily be understood that when the cover 1 is in its first position, it is not possible to insert a key in the lock 4 in order to open or close the door 3: to be able to do this, it is necessary to cause said cover to pivot so as to bring it into its second position.

As can be seen in dotted lines in FIG. 1, and more clearly in FIG. 2, the inside face of the cover 1, i.e. its face that faces towards the door 3, carries two electrical contact elements 51 and 52 that, when said cover 1 is in its first position, are in contact with a projecting cylinder 41 of said lock. More precisely, the first electrical contact element 51 extends perpendicularly to the inside face of the cover so as to be capable of coming into contact with a side face 410 of said cylinder, and it is preferably rounded so as to match the shape thereof. Advantageously, the first electrical contact element 51 may be a magnet or made of magnetized material, so as to ensure good contact and so as to hold the cover firmly in its second position. The second electrical contact element is a metal plate 52 that extends parallel to the inside face of the cover so as to be capable of coming into contact with a front surface 411 of the cylinder. Optionally, the second electrical contact element 52 may be constituted merely by a conductive portion of said inside face of the cover 1.

FIG. 2 shows that the cover 1 is constituted by a back plate 10 that is substantially flat or slightly bulging, and a rim 11 extending perpendicularly to the back plate 10 around its entire perimeter with the exception of a region 12 where the rim 11 is absent so as to allow the cylinder 41 to pass when said cover pivots. The rim 11 prevents an intruder from gaining access via the sides to the electrical contact elements 51 and 52. If there were no such rim 11, then electrical continuity could be established between said contact elements in such a manner that the detector would be incapable of detecting the cover 1 passing from the first position to the second position.

FIG. 3 is a section view through the detector when the cover 1 is in its first position, thus showing how the electrical contact elements 51 and 52 come into contact with the cylinder 41 of the lock 4.

As shown diagrammatically in the left-hand portion of FIG. 5, when the cover 1 is in its first position, the cylinder 41 constitutes a conductive section of an electric circuit 6. When the cover 1 is taken to its second position, the contact elements 51 and 52 are spaced apart from said cylinder 41 and the circuit 6 is open. Thus, when the cover 1 passes from the first position to the second position, the circuit 6 opens, thereby generating an electrical signal S1 that is represented in FIG. 5 in the form of a falling front. Conversely, when the cover 1 passes from the second position to the first position, the circuit 6 closes, thereby generating an electrical signal S2 that is represented in FIG. 5 in the form of a rising front.

Optionally, display means may be provided to indicate that the detector is operational, and/or whether the cover 1 is in its first position or its second position. For example, as shown in FIGS. 1, 2, and 5, the circuit 6 may include a light-emitting diode (LED) 7 connected in series. The LED is on only when the cover 1 is in its first position, i.e. when contact is made. This enables an authorized user to detect a situation in which the cover has not been properly returned to its first position after the door has been opened and the key extracted, and thus avoid triggering the alarm signal in untimely manner. A configuration that is more complete, but within the competence of the person skilled in the art, enables two LEDs of different colors to be used, one of which is on only when the cover is in its first position and the other of which is on only when the cover is in its second position.

In order to avoid untimely triggering of an alarm signal following the opening of a door by an authorized person and the removal of the key from the lock 4, it is advantageous for the cover 1 to return automatically to its first position. In the embodiment shown in the figures, the cover 1 is returned to the first position by gravity. The presence of a magnet or of a magnetized material also makes it possible to confer a stable nature on the first position. In a variant or in combination, it is possible to provide return means, such as a spring.

The cover 1 is mounted on the outside 31 of the door 3 by mounting means 2 of structure that can clearly be seen in FIG. 4. The mounting means comprise two coaxial elements, a tubular element 21 that is inserted from the inside 32 of the door 3, and a pin 22 secured to the cover 1 and designed to be inserted in the tubular element 21 so as to pivot about the axis z. The pin 22 extends perpendicularly to the surface of the cover 1 along the axis z which constitutes the pivot axis of said cover. One of its ends, given reference 220, is welded to the outside face of the cover 1; its opposite end, for insertion in the tubular element 21, includes retention means 221. The retention means 221 are constituted by a plurality of tabs sloping rearwards and flexibly mounted on the pin. These tabs flex when the pin 22 is inserted in the tubular element so as to avoid hindering said insertion, and they open on leaving said tubular element so as to permanently prevent extraction of said pin 22. The tabs then bear on an annular extension 210 of the tubular element 21, perpendicularly to the body 21 thereof.

Advantageously, the pin 22 presents an axial opening 222 through which two electric wires 60 and 61 pass that are connected respectively to the first and to the second contact elements 51 and 52. In this way, in addition to providing a fastener and hinge function, the pin 22 also performs an electrical connection function between the elements that are on the outside 31 of the door 3 (cover 1 with the contact elements 51 and 52, LED 7) and the elements that are on the inside 32 thereof (in particular the alarm unit).

In a first embodiment of an alarm system of the invention, the attempted lock break-in detector is connected directly by the wires 60 and 61 to an alarm unit CA that may be of conventional type, as shown in FIG. 5. When the cover 1 is taken from the first position to the second position, a signal S1 corresponding to the circuit 6 opening reaches said alarm unit CA, which unit is programmed to trigger an alarm signal if it does not receive, before a predetermined duration has elapsed, a signal S2 corresponding to the circuit 6 closing and indicating that the cover 1 has returned to its first position. The predetermined duration is generally programmable and may be set to 10 seconds (s), 15 s, or 30 s, for example.

In a second embodiment, also shown in FIG. 5, the alarm unit CA is much simpler, since it does no more than trigger an alarm signal on receiving a signal ST indicative of an attempted break-in. The detector of the invention must therefore include timer means T receiving as input the signals S1 and S2 and generating said signal ST indicative of an attempted break-in if the cover 1, after being taken from the first position to the second position, does not return to said first position before the predetermined duration has elapsed.

The signal ST transmitted to the alarm unit CA need not necessarily include its own timer means. The timer means T may be situated inside the cover 1 or in a housing situated on the inside 32 of the door 3, with this second position guaranteeing better security. Under such circumstances, the maximum duration that may elapse between the two signals S1 and S2 without the signal ST being generated should preferably be programmable, e.g. by acting on microswitches of the timer means T.

Naturally, whatever the embodiment selected, the alarm unit CA may be connected to a plurality of detectors of the invention, the detectors being installed on different locks, and also to detectors of other types, such as movement detectors. In known manner, the detectors may be connected to the unit CA via wired or wireless connections. The attempted lock break-in detector of the invention can easily be integrated in an existing alarm system.

The attempted lock break-in detector is described above with reference to a particular embodiment, however numerous variants are possible without going beyond the ambit of the invention.

A particularly advantageous variant of the invention is shown in FIGS. 6A and 6B.

In this variant, the rim 11 extends around only two sides of the cover 1; the region 12 where the rim 11 is absent is thus of large size. Nevertheless, this region 12 is closed by a second rim 13 that is fastened to the door 3, and therefore does not follow the cover 1 while it is pivoting. An auxiliary lock 70 enables the pivoting cover 1 to be locked to said second rim 13, e.g. by means of a hook 71 engaging in a notch 72 formed in the surface thereof. Thus, in order to be able to pivot the cover 1 so as to gain access to the main lock 4, it is necessary to begin by opening the auxiliary lock 70.

This variant of the invention enables the main lock 4, generally a very expensive security lock, to be protected from acts of vandalism consisting in damaging the lock by introducing glue or chewing gum into its keyhole 40. In accordance with the invention, only the auxiliary lock 70 that can be replaced at low cost remains exposed to malicious acts. The auxiliary lock 70 may also be hidden by a pivoting flap 80 made of metal or of plastics material, that is fastened to the outside surface of the cover 1 by a hinge 81, e.g. including a spring or more generally a resilient hinge, and may optionally be capable of being held in place by a magnet 81.

The use of a second rim 13 fastened to the door for completely “closing” the perimeter of the cover 1 and thus preventing any access to the inside surface thereof can be useful even in the absence of an auxiliary lock 70.

The invention is described in its application to the door lock of a dwelling, however it will be understood that it can equally well be applied to the lock of a car door, a drawer, a safe, etc.

The cover 1 need not necessarily pivot about an axis perpendicular to the plane of the door. It could also pivot about an axis that is horizontal or vertical and that lies in said plane, or it could move in translation, vertically or horizontally.

Furthermore, there is no need for the cover 1 to have two elements for making contact with the cylinder 41 of the lock: one of the two contact elements needed for closing the electric circuit 6 may be stationary and situated on the inside 32 of the door 3. In this embodiment, the cylinder 41 itself forms a conductive path between the two opposite sides of said door. Under such circumstances, only one electric wire needs to pass through the axial opening 222 in the pin 22.

Furthermore, the invention is not limited to conventional mechanical locks, but may be applied to any kind of lock, for example to locks using magnetic or punched cards, or indeed to electronic locks with a keypad. Under such circumstances, the cover 1 should naturally be adapted to prevent access not to a keyhole, but to the means that are provided for opening or closing the lock in question, such as a slot for inserting a card or at least one key of a digital keypad.

1. An attempted lock break-in detector comprising:
a cover provided with mounting means for mounting on a door provided with a lock, said cover being capable of passing from a first position in which it covers means for opening or closing said lock so as to make said means inaccessible, to a second position in which it allows access to said opening or closing means, and vice versa; and
means for opening and closing an electric circuit to generate and interrupt an electrical signal indicative of said cover passing from the first position to the second position, and vice versa; the detector being characterized in that said means for opening and closing an electric circuit comprise at least one contact element for making contact with an element of said lock, which lock element constitutes a section of said electric circuit.

2. An attempted lock break-in detector according to claim 1, wherein said contact element is arranged in such a manner as to be in contact with said element of the lock to close said electric circuit when the cover in its first position, and to be spaced apart from said element of the lock to open said electric circuit when the cover is in its second position.

3. An attempted lock break-in detector according to claim 1, wherein said lock is a lock having a key and said means for opening or closing said lock comprise a keyhole.

4. An attempted lock break-in detector according to claim 3, wherein said element of a lock is a cylinder.

5. An attempted lock break-in detector according to claim 4, wherein said means for opening and closing an electric circuit comprise at least a first contact element that, when said cover is in said first position, is in contact with a side surface of said cylinder projecting from said door, and that, when said cover is in said second position, is no longer in contact with said cylinder.

6. An attempted lock break-in detector according to claim 5, wherein said means for opening and closing an electric circuit also comprise a second contact element that, when said cover is in said first position, is in contact with a front surface of said cylinder, and that, when said contact is in said second position, is no longer in contact with said cylinder.

7. An attempted lock break-in detector according to claim 1, wherein said at least one contact element is magnetized.

8. An attempted lock break-in detector according to claim 1, also including return means for returning said cover from said second position towards said first position.

9. An attempted lock break-in detector according to claim 1, wherein the mounting means of said cover are adapted to enable said cover to pivot about an axis perpendicular to the surface of said door.

10. An attempted lock break-in detector according to claim 9, wherein said mounting means of said cover comprise:
a tubular element for passing through said door;
a pin fastened to said cover at one of its ends and extending perpendicularly thereto, said pin being adapted to pass through said tubular element and to pivot in the tubular element; and
retention means for retaining said pin inside said tubular element.

11. An attempted lock break-in detector according to claim 10, wherein said pin includes an axial opening through which there passes at least one electric wire connected to said means for generating a signal indicative of said cover passing from the first position to the second position, and vice versa.

12. An attempted lock break-in detector according to claim 1, also including at least one display means suitable for indicating whether said cover is in the first position or in the second position.

13. An attempted lock break-in detector according to claim 1, also including an auxiliary lock for locking said cover in said first position.

14. An attempted lock break-in detector according to claim 1, also including timer means for generating a signal indicative of an attempted break-in if said cover, after being taken from the first position to the second position, does not return to said first position before a predetermined duration has elapsed.

15. An alarm system including an attempted lock break-in detector according to claim 14 and an alarm unit, said alarm unit being adapted to receive said signal indicative of an attempted break-in, and consequently to trigger an alarm signal.

16. An alarm system comprising an attempted lock break-in detector according to claim 1, and an alarm unit, said alarm unit being adapted to receive said signal indicative of said cover passing from the first position to the second position, or vice versa, and for triggering an alarm signal if reception of a signal indicative of a passage of said cover from the first position to the second position is not followed, before a predetermined duration has elapsed, by a signal indicative of a return of the cover to said first position.

17. A lock provided with an attempted lock break-in detector according to claim 1.

18. A door provided with a lock according to claim 17.
